(19) United States
(12) Patent Application Publication
(10) Pub. No.: US 2005/0168579 A1
(43) Pub. Date: Aug. 4, 2005

(54) Imaging system

(76) Inventor: Ayami Imamura, Tokyo (JP)

Correspondence Address: KENYON & KENYON, 1 BROADWAY, NEW YORK, NY, 10004, US

(21) Appl. No.: 11/008,997

(22) Filed: Dec. 13, 2004

(30) Foreign Application Priority Data
Dec. 16, 2003 (JP) 2003-417526

(51) Int. Cl. H04N 5/225

(52) U.S. Cl. 348/207.99

(57) ABSTRACT

The invention relates to an electronic camera or other imaging system that is less susceptible to shake, makes an optical system less susceptible to decentration by distortion of a body itself, and enables taking without locating any button on a side face. The imaging system 10 comprises an image pickup optical system, an image pickup device and a shutter. Shutter release takes place in response to a detection signal from a microphone 13 for detecting a sound wave, or the like.

This application claims benefit of Japanese Application No. 2003-417526 filed in Japan on Dec. 16, 2003, the contents of which are incorporated herein by this reference.

### BACKGROUND OF THE INVENTION

The present invention relates generally to an imaging system that is less susceptible to shake or body distortion upon operation of a shutter, and more specifically to a card or other form of thin imaging system.

Mechanisms for prevention of camera shake upon operation of shutters in silver-halide cameras or digital cameras (electronic cameras) have been proposed so far in the art. One typical mechanism presented until now involves optical or thermal detection of the movement of a finger to put the shutter in operation.

### SUMMARY OF THE INVENTION

According to one aspect of the invention, there is provided an imaging system comprising an image pickup optical system, an image pickup device and a shutter, characterized by further comprising an input portion for putting said shutter into operation, wherein said input portion comprises a non-contact type detector.

According to another aspect of the invention, there is provided an imaging system comprising an image pickup optical system, an image pickup device and a shutter, characterized by further comprising an input portion for putting said shutter into operation, wherein said input portion comprises a touch sensor.

According to yet another aspect of the invention, there is provided an imaging system comprising an image pickup optical system, an image pickup device and a shutter, characterized by further comprising an imaging system body including therein said image pickup optical system, said image pickup device and said shutter, a holder portion adjacent to said imaging system body and an input portion for putting said shutter into operation, wherein a boundary between said holder portion and said imaging system body or said holder portion per se is bendable, with bending detection means for detecting a bending of the boundary between said holder portion and said imaging system body or said holder portion per se, wherein said input portion is said bending detection means.

According to a further aspect of the invention, there is provided an imaging system comprising an image pickup optical system, an image pickup device and a shutter, characterized by further comprising an input portion and a processing unit for putting said shutter into operation, wherein said input portion comprises a plurality of detectors, and said processing unit puts said shutter into operation in response to signals produced out of at least two detectors of said detectors.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is generally illustrative in schematic of one exemplary arrangement of a thin card-form of imaging system to which the invention is to be applied. Specifically, FIGS. 1(a) and 1(b) are a top view and a sectional side view of that imaging system.

FIG. 2 is generally illustrative in schematic of one exemplary arrangement of an image pickup optical system in the imaging system of FIG. 1. Specifically, FIG. 2(a) and 2(b) are a top view and a sectional side view of that image pickup optical system.

FIG. 3 is generally illustrative of one exemplary construction of a taken image relative to a synthesized image in the imaging system of FIG. 1. Specifically, FIG. 3(a) shows a synthesized image having an aspect ratio of 3:4, FIG. 3(b) shows a synthesis screen having any arbitrary aspect ratio, and FIG. 3(c) shows a synthesized image having an aspect ratio of 16:9.

FIG. 4 is a rear view of the camera according to Example 1 of the invention.

FIG. 5 is a block diagram of one exemplary arrangement of Example 1 for how sounds are detected to generate trigger signals.

FIG. 6 is a block diagram of another exemplary arrangement of Example 1 for how sounds are detected to generate trigger signals.

FIG. 7 is a block diagram for how voices are recognized at a voice processing circuit in Example 1.

FIG. 8 is a rear view of the camera according to Example 2 of the invention.

FIG. 9 is a block diagram of one exemplary arrangement of detecting extraneous light to generate a trigger signal in Example 2.

FIGS. 10(a) and 10(b) illustrate (a) the arrangement and (b) the action of a photodetection portion comprising a light source and a photodetector in Example 2.

FIG. 11 is a block diagram of one exemplary arrangement of detecting light with the arrangement of FIG. 9 to generate a trigger signal.

FIG. 12 is a rear view of the camera according to Example 3 of the invention.

FIG. 13 is a block diagram illustrative of one exemplary arrangement of detecting a touch to generate a trigger signal in Example 3.

FIGS. 14(a) and 14(b) are a rear view and a top view, respectively, of the camera according to Example 4 of the invention.

FIGS. 15(a) and 15(b) are a partially horizontal section view and a partial front view, respectively, of the camera of Example 4, wherein a strain gauge is applied over the inside of a boundary portion between the camera body and the holder section.

FIGS. 16(a) and 16(b) are a partially horizontal section view and a partial front view, respectively, of the camera of Example 4, wherein a strain gauge is applied over the inside of the holder section.

FIG. 17 is a block diagram of one exemplary arrangement of generating a trigger signal in response to a bending or deflection detected by the strain gauge of FIG. 15, and FIG. 16.

FIGS. 18(a) and 18(b) are a partially horizontal section view and a partial front view, respectively, of the camera of Example 4, wherein a piezoelectric element is applied over the inside of a boundary portion between the camera body and the holder section.

FIGS. 19(a) and 19(b) are a partially horizontal section view and a partial front view, respectively, of the camera of Example 4, wherein a piezoelectric element is applied over the inside of the holder section.

FIG. 20 is a block diagram of one exemplary arrangement of generating a trigger signal in response to a bending or deflection detected by the piezoelectric element of FIG. 18, and FIG. 19.

FIGS. 21(a) and 21(b) are generally illustrative of how to basically detect light from a built-in light guide to detect a bending or deflection of the holder section.

FIG. 22 is illustrative of how to detect deflection of the holder section itself to trigger the shutter into operation.

FIG. 23 is illustrative of how to detect a bending of the boundary between the holder section and the camera body to trigger the shutter into operation.

FIG. 24 is a block diagram of one exemplary arrangement for generating a trigger signal in response to a bending or deformation detected by the light guide of FIG. 21, FIG. 22, and FIG. 23.

FIG. 25(a) is a rear view of the camera according to Example 5 of the invention, and FIG. 25(b) is a sectional view of one exemplary construction of each pressure sensor.

FIG. 26 is a rear view of a camera according to one modification to Example 5.

FIG. 27 is a block diagram of one exemplary arrangement for generating a trigger signal in response to grip pressure detected by a plurality of sensors.

FIGS. 28(a) and 28(b) are logic circuit diagrams illustrating logics for generating a trigger signal at the CPU of FIG. 27, using two pressure sensors and four pressure sensors, respectively.

### DESCRIPTION OF THE PREFERRED EMBODIMENTS

A general construction of the imaging system according to the invention will first be given, and the imaging system of the invention will then be explained specifically with some examples.

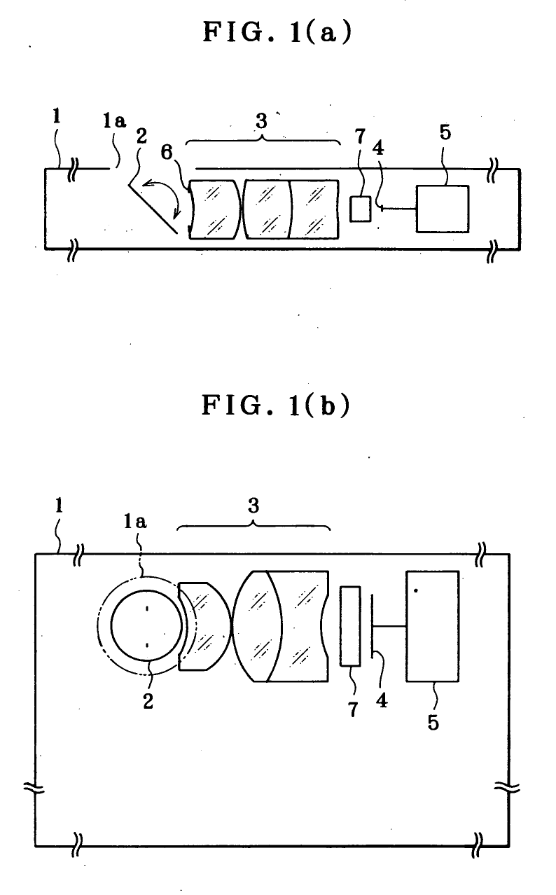

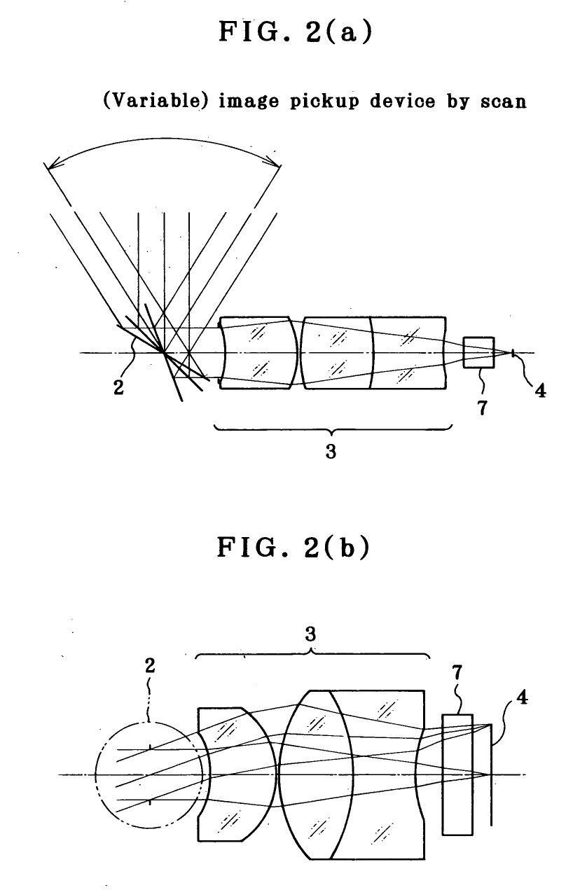

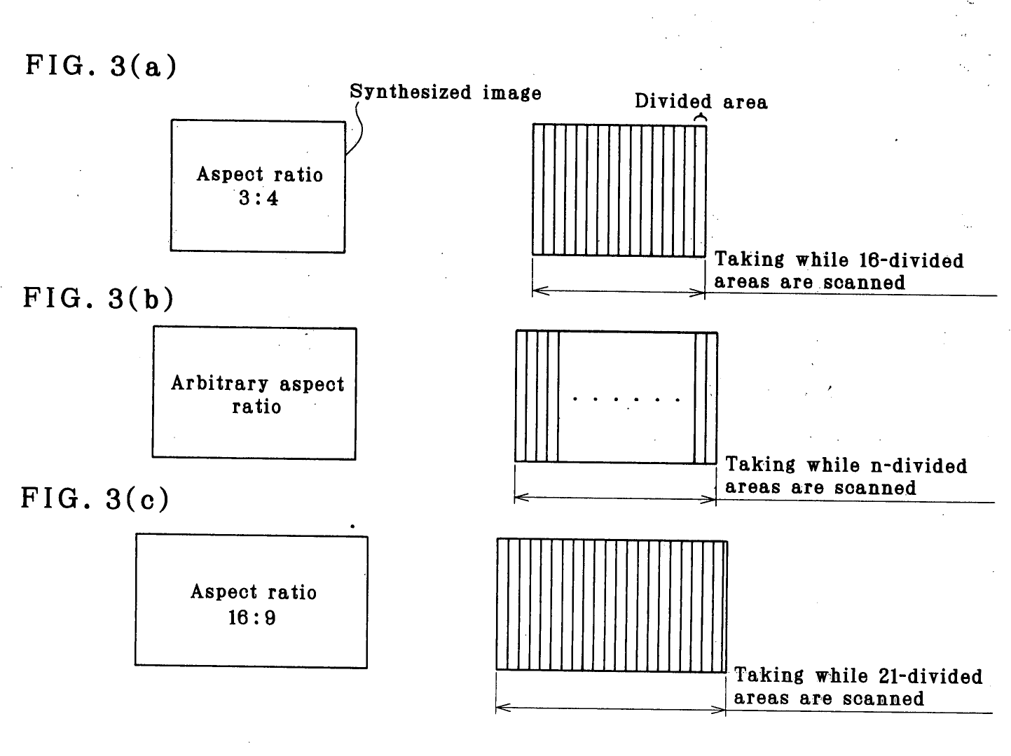

One exemplary arrangement of the imaging system is here explained with reference to a card-type camera that is very thin in the taking direction. FIG. 1 is illustrative in schematic of one general arrangement of the card-type imaging system, and FIG. 2 is illustrative in schematic of one general arrangement of an image pickup optical system used with that imaging system. FIGS. 1(a) and 1(b) are a top view and a sectional side view of that imaging system, respectively, and FIGS. 2(a) and 2(b) are a top view and a sectional side view of that image pickup optical system, respectively. FIG. 3 is generally illustrative of one construction of a taken image relative to a synthesized image in that imaging system; FIG. 3(a) shows a synthesized image having an aspect ratio of 3:4, FIG. 3(b) shows a synthesis screen having any arbitrary aspect ratio, and FIG. 3(c) shows a synthesized image having an aspect ratio of 16:9.

This imaging system is built up of a main housing (body) 1 of the card, in which there are housed a one-dimensional scan mirror 2, a lens group 3, a two-dimensional image pickup device 4 and an image synthesis means 5. The two-dimensional image pickup device 4 picks up images on the area to be scanned by the one-dimensional scan mirror 2. The image synthesis means 5 puts together images picked up by the two-dimensional image pickup device 4 into one synthesis screen. In FIG. 1, 1a stands for a taking aperture portion, 6 an aperture stop that, for instance, has a fixed aperture shape, and 7 a cover glass for the two-dimensional image pickup device of flat shape.

The one-dimensional scan mirror 2 is made up of a MEMS (micro-electro-mechanical system) gimbal mirror.

The lens group 3 has varying contour size in two orthogonal directions, and is of flat shape. The flat direction is such that the contour size becomes small in the direction of deflection of light rays by the one-dimensional scan mirror 2, and the image pickup plane of the two-dimensional image pickup device 4 is of flat shape as well. Accordingly, the lens group 3 is located such that the thickness becomes small in the same direction as the widthwise direction of the image pickup plane of the two-dimensional image pickup device 4. In other words, the optical system 3 of flat shape is the same as the two-dimensional image pickup device 4 of flat shape in terms of flat direction.

The two-dimensional image pickup device 4, too, is of flat shape. More specifically, the image pickup plane is of flat shape, and satisfies the following condition:
0.05<α<0.5
where α is the aspect ratio of the image pickup plane.

The number of pixels that the two-dimensional image pickup device 4 has is such that one synthesized image is divided into 2 to 32 taken images. With the imaging system of this example, one synthesized image is generated by way of the image synthesis means 5, wherein the synthesized image is generated using n individual images (n=2 to 32) as desired. In other words, the imaging system of this example is constructed such that one image of the above n individual images provides an image taken by one scanning. The number of such individual images is determined by the rotating speed of the scan mirror 2 and the taking time of the two-dimensional image pickup device 4.

When, as shown typically in FIG. 3, 16 images taken while scanned are synthesized into one image, the synthesized image has an aspect ratio of 3:4. When 21 images taken while scanned are synthesized into one image, the synthesized image has an aspect ratio of 16:9. With the imaging system of this example, it is thus possible to vary the aspect ratio of the synthesized image as desired while the n individual areas (n is an integer and 2≦n≦32) are scanned. The taking time by the two-dimensional image pickup device 4 for each scan, and the scan speed of the scan mirror 2 is given by the time corresponding to how many areas one synthesized image is divided to when one synthesized image is generated with one shutter.

With the thus assembled imaging system of this example, while scanning is carried out by the one-dimensional scan mirror 2 n times at varying mirror angles, a given taking range of light incident from the aperture portion 1a and divided by the one-dimensional scan mirror 2 is reflected to pick up images at the two-dimensional image pickup device 4 by way of the lens group 3 and the cover glass 6. The images picked up for each scan are put together by the image synthesis means 5. With n scans finished, one synthesized image is formed in complete form.

The flat image plane of the two-dimensional image pickup device 4, for instance, has a pixel size of 2.8 μm and 1,200 pixels×100 pixels, and the maximum optical surface size in the lens group of flat shape is 2.4 mm×5.56 mm.

The main housing 1 of the card in this example may have been designed to have a thickness of 2.4 mm to 5 mm inclusive.

In accordance with such an imaging system wherein images taken for each scan by the scan mirror are synthesized into one image, the aspect ratio can be changed by varying the number of the taken images to be synthesized.

Further, as any desired image is selected as the start one from the taken images to be synthesized, it allows the center of the subject in the synthesized image to be selectively changed along one direction (for instance, a horizontal direction).

The use of the scan mirror 2 that enables an optical path to be bent contributes to making the imaging system smaller. With both the optical system 3 and the two-dimensional image pickup device 4 configured into a flat shape in the same direction, the imaging system can be much more reduced in thickness and size.

Although the one-dimensional scan mirror 2 is here constructed of the MEMS gimbal mirror, it is understood that the one-dimensional scan mirror 2 may be constructed, using a bari-angle rotating mirror.

In such an imaging system, optical distortion often results from an optical system comprising the one-dimensional scan mirror 2 and the lens group 3. However, it could be corrected by such electrical correction means as set forth in the prior art (JP(A) 8-256295).

Some specific examples are given below.

### EXAMPLE 1

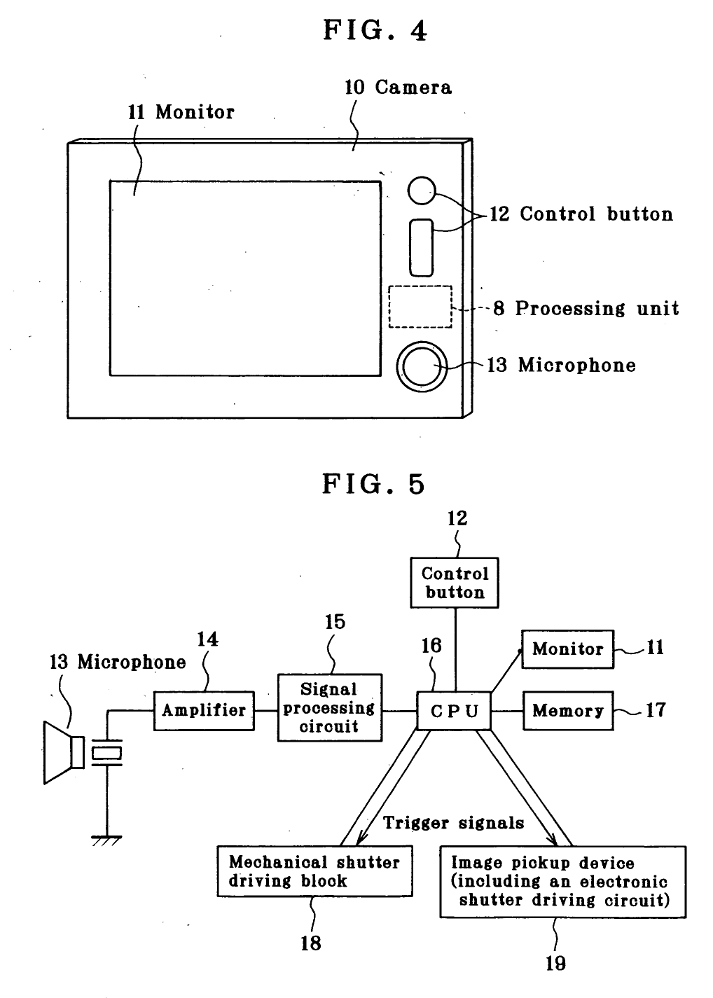

FIG. 4 is a rear view of the imaging system of Example 1. This imaging system is embodied in the form of such a card-type camera 10 as exemplified in FIGS. 1 to 3. It is here noted that the camera 10 may be an optical system that has no scan mirror, and instead includes a mirror or reflecting prism for bending an associated optical path or, alternatively, the camera 10 may have a finder not shown.

As depicted in FIG. 4, the camera 10 comprises on its back surface a microphone 13, a monitor (e.g., a liquid crystal display) 11 and a control button 12, with a built-in processing unit 8. It is here noted that the image pickup optical system, control circuit, memory, etc. that must be included in the camera 10 are not shown. The control button 12 is provided to set taking conditions, etc. and perform image control (processing) in a memory. As the user operates the control button 12, for instance, it causes the cursor to move across a menu appearing on the monitor 11. Then, as menu items are chosen as an example, mode selection or sensitivity selection is settageble or, alternatively, image lists or the desired image appears.

The imaging system of this example comprises the microphone 13 as a non-contact type detector. As sounds are detected by the microphone 13 upon taking, they are used as a trigger to put the shutter into operation, setting off taking. That is, the imaging system of the present example is provided with the microphone 13 as the input portion for putting the shutter into operation, and that microphone 13 plays a shutter release button.

Thus, the imaging system of the instant example can put the shutter into operation in a non-contact fashion. In other words, the shutter can be put into operation without applying force to the camera 10 with the result that blur-free good images can be obtained. The optical system, because of being less susceptible to distortion and decentration, also ensures good images.

The camera 10 is friendly to those with disabilities, tender children and those who have trouble in fine handling, because it is only needed for those to give out voices or sounds. Since the user can take hold of the camera 10 with both hands, camera shake can be more effectively held back.

The absence of any shutter release button can diminish the number of control buttons, making the monitor 11 larger.

The detection of sounds by way of the microphone 13 may be achieved as follows.
(1) A given threshold value is preset. When the magnitude of sound obtained at the microphone 13 is greater than the preset threshold value, the shutter is triggered into operation. In this case, it is acceptable to preset the threshold value by the frequency, not the magnitude, of sound.
(2) A given voice is preset. When the voice obtained at the microphone 13 is analyzed to be a specific word, the shutter is put into operation. That is, as the specific word is recognized, the imaging system puts the shutter into operation. For instance, such a given voice or command may be “Cheese!”, “Shutter!” or the like. With the specific word preset, the shutter is unlikely to respond to ordinary conversations, surrounding noises or the like, which may otherwise lead to malfunction. Further, if specific operations are allocated to a plurality of words, it is then possible not only to put the shutter into operation but also to use voices to switch the camera 10 from one zoom state or taking mode over to another, and switch a flash, from ON over to OFF and vice versa, or the like. Furthermore, if such a specific word as mentioned above has also a certain sound-level threshold value so that various operations can be performed only when it is exceeded, malfunction can then be more effectively prevented.
(3) The shutter is put into operation in response to a change in the sound detected at the microphone 13. For instance, the microphone 13 is so designed to be closed off by a finger that as the finger comes off, the shutter can be put into operation. While the microphone 13 is closed off by the finger, there is little or no sound going in. As the finger comes off in this state, surrounding noises and so on are detected, resulting in an instantaneous change in the sound level. As the sound level is monitored and drastic changes are detected, it causes the shutter to be put into operation. In this case, the user can feel free and easy to perform taking because of no need of giving out large sounds, specific voices and so on.

The above arrangement makes use of the sound level detected at the microphone 13 changing from a low to a high level. The sound level detected at the microphone 13 changing from a high to a low level, too, may be used. Specifically, as the microphone 13 is closed off with the finger from an unclosed state, there are such changes. In this case, the shutter is put into operation the moment the sound level detected at the microphone 13 drops drastically.

Referring again to the above (3), surrounding natural sounds are utilized. Apart from this, it is acceptable to incorporate in the imaging system a sound source that produces a sound of given frequency, so that the shutter can be put into operation depending on whether or not there is a sound from the sound source. The use of the sound of specific frequency is helpful for prevention of malfunction.

In any of the above embodiments (1) to (3), a sound detection mode is preferably installed. As such sounds or voices as referred to in the above (1) to (3) are detected in the sound detection mode, the shutter is triggered into operation. With the sound detection mode not set, however, the shutter is not triggered. This ensures to prevent malfunction such as a sudden shutter actuation in choosing composition.

FIG. 5 is illustrative of one exemplary arrangement of sound detection. Specifically, FIG. 5 is a block diagram for signal processing in taking images according to the above (1) or (3) embodiment. In this arrangement, a piezoelectric microphone is used as the microphone 13. A sound signal from the microphone 13 is amplified at an amplifier 14, entering a signal processing circuit 15. At the signal processing circuit 15, whether or not the sound level is greater than the threshold value is determined in the case of (1), and whether or not there is a drastic change in the sound level is determined in the case of (3). In either case, if the shutter is to be put in operation, a given control signal is then sent out to CPU 16.

At CPU 16, whether or not the sound detection mode is set by a control button 12 is determined. With the sound detection mode set, a shutter driving trigger signal is sent from CPU 16 to a mechanical shutter driving block 18 with the result that a mechanical shutter is put into operation. Since another trigger signal is also sent to an image pickup device 19, an electronic shutter on the image pickup device 19 is operated in association with the operation of the mechanical shutter, and image information is stored as well. In this way, images are taken. With the sound detection mode not set, on the other hand, both the mechanical shutter and the electronic shutter are not driven. While both the mechanical shutter and the electronic shutter are used in this example, it is understood that it is possible to rely upon only one of them. With the mechanical shutter alone, the trigger signals are fed to the mechanical shutter driving block 18 and the image pickup device 19 to put the mechanical shutter into operation and store the image information. With the electronic shutter alone, on the other hand, the trigger signal is fed to the image pickup device 19 to put the electronic shutter into operation and store the image information.

It is here noted that CPU 16 is connected with a monitor 11, a memory 17 and the image pickup device 19, so that images picked up by the operation of the shutter are stored in the memory 17, and the images picked up by the image pickup device 19 and the images stored in the memory 17 are displayed on the monitor 11 by way of a control signal from the control button 12. Although the processing unit used herein is built up of the signal processing circuit 15, it may further include CPU 16.

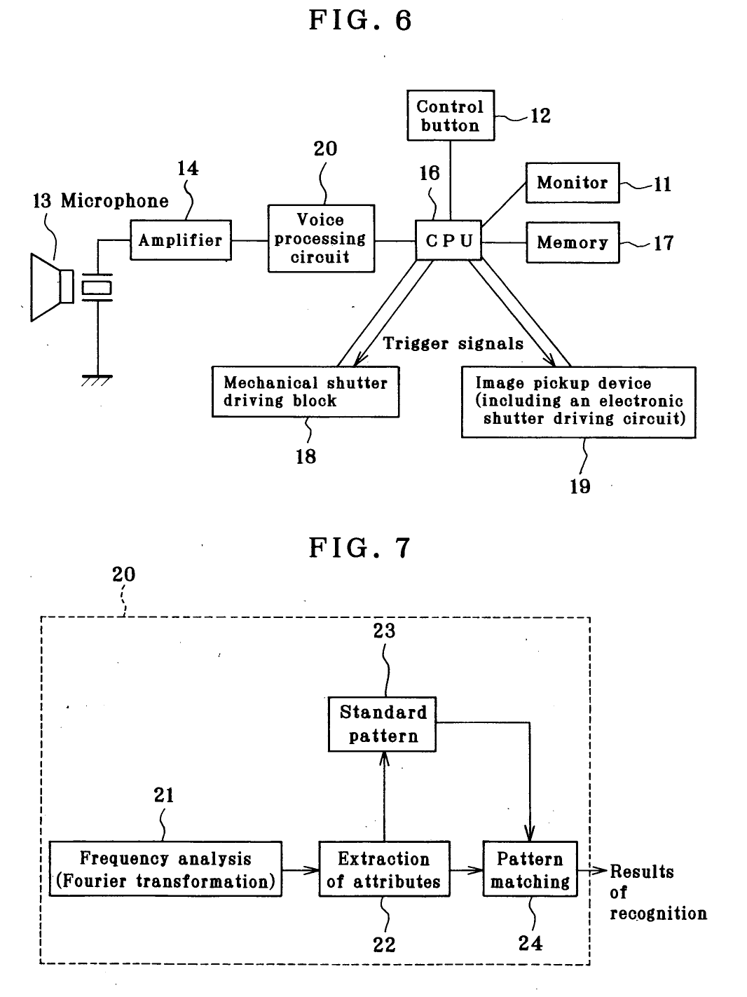

FIG. 6 is illustrative of one exemplary arrangement of voice detection. Specifically, FIG. 6 is a block diagram of signal processing in taking images according to the above (2) embodiment. In this arrangement, too, a piezoelectric microphone is used as the microphone 13. A voice signal from the microphone 13 is amplified at an amplifier 14, and then sent to a voice processing circuit 20.

FIG. 7 is a block diagram of how voices are recognized at the voice processing circuit 20. A voice signal entering the voice processing circuit 20 is subjected to Fourier transformation for frequency analysis (block 21). Subsequently, an attribute pattern is extracted from the resulting frequency spectrum (block 22). The extracted attribute pattern is compared with a standard pattern 23. As both patterns match (pattern matching) (block 24), the attribute pattern is recognized as a specific word. Now with the sound detection mode set, trigger signals are sent from CPU 16 to a shutter driving block 18 and an image pickup device 19 with the result that a mechanical shutter and an electronic shutter are operated to pick up images. With the sound detection mode not set, on the other hand, both the shutters are not driven.

As in FIG. 6, the CPU 16 is connected with a monitor 11, a memory 17 and the image pickup device 19, so that images picked up by the operation of the shutter are stored in the memory 17, and the images picked up by the image pickup device 19 and the images stored in the memory 17 are displayed on the monitor 11 by way of a control signal from a control button 12.

It is here noted that a plurality of verbal patterns may be registered as the standard pattern 23, and different operations are assigned to those verbal patterns. This ensures that the shutters are not only operated but also switchover of the camera 10 from one zoom state and taking mode to another, turning a flash on or off, etc. is performed by way of voices.

### EXAMPLE 2

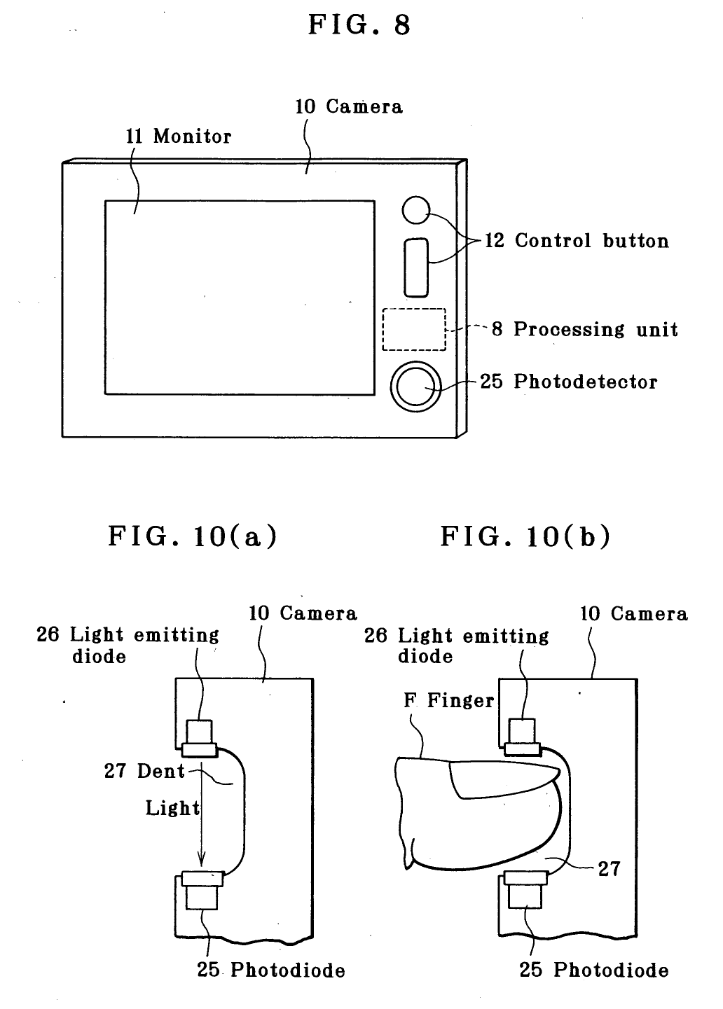

FIG. 8 is a rear view of the imaging system of Example 2. This imaging system is also embodied in the form of such a card-type camera 10 as in Example 1. It is here noted that the camera 10 may be an optical system that has no scan mirror, and instead includes a mirror or reflecting prism for bending an associated optical path or, alternatively, the camera 10 may have a finder not shown.

As depicted in FIG. 8, the camera 10 comprises on its back surface a photodetector 25, a monitor (e.g., a liquid crystal display) 11 and a control button 12, with a built-in processing unit 8. It is here noted that the image pickup optical system, control circuit, memory, etc. that must be included in the camera 10 are not shown. The control button 12 is provided to set taking conditions, etc. and perform image control (processing) in a memory. As the user operates the control button 12, for instance, it causes a cursor to move across a menu appearing on the monitor 11. Then, as menu items are chosen as an example, mode switchover or sensitivity switchover is settable or, alternatively, image lists or the desired image appears.

The imaging system of this example comprises the photodetector 25 as a non-contact type detector. As light is detected by the photodetector 25 upon taking, it allows the light to be used as a trigger to put the shutter into operation, setting off taking. That is, the imaging system of the present example is provided with the photodetector 25 as the input portion for putting the shutter into operation, and that photodetector 25 plays a shutter release button.

Thus, the imaging system of the instant example can put the shutter into operation in a non-contact fashion. In other words, the shutter can be put into operation without applying force to the camera 10 with the result that blur-free good images can be obtained. The optical system, because of being less susceptible to distortion and decentration, ensures good images.

The absence of any shutter release button can reduce the number of control buttons, making the monitor 11 larger.

The detection of light by way of the photodetctor 25 may be embodied as follows.

(1) A given threshold value is preset. When the intensity (the brightness and quantity of light) of light obtained at the photodetector 25 is greater (brighter) than the preset threshold value, the shutter is triggered into operation. In this case, it is acceptable to preset the threshold value by the frequency, not the intensity, of light. A light or the like may be used as a source of light going in the photodetector 25. The light detected at the photodetector 25 is not limited to visible light, and may be infrared radiation or the like. The light source may be attached to the camera 10 as a one-piece or a separate piece.

(2) The shutter is triggered into operation in response to a change in the light detected at the photodetector 25. For instance, the photodetector 25 is so designed to be closed off by a finger that as the finger comes off, the shutter can be triggered into operation. While the photodetector 25 is closed off by the finger, little or no light is detected. As the finger comes off the photodetector 25 in this state, ambient light is detected except for where there is a pitch-dark circumstance, leading to an instantaneous change in the intensity of light. As the photodetector monitors the intensity of light and senses drastic changes, it triggers the shutter into operation. In this embodiment, the shutter can be triggered into operation without recourse to any special light source, and the user can feel free and easy to take images.

In this embodiment, the shutter is triggered into operation when a difference in the light quantity between entrance and no entrance of light is greater than the threshold value. It is here noted that the threshold value may freely be set in a stepwise manner or a continuous manner. In a dark circumstance, the threshold value is set so low that the shutter can be triggered into operation in response to a little bit change in the quantity of light. In a bright state, on the contrary, the threshold value is set so high that the shutter can remain fixed even when there is a little bit displacement of the finger placed on the photodetector 25. Therefore, malfunction can be prevented.

The above embodiment makes use of the intensity of light detected by the photodetector 25 changing from a low to a high value. The intensity of light detected at the photodetector 25 changing from a high to a low value, too, may be used. Specifically, as the photodetector 25 is closed off with the finger from an unclosed state, there are such changes. In this case, the shutter is put into operation the moment the intensity of light detected by the photodetector 25 drops drastically.

Preferably in that case, the quantity of light, at which the photodetector is taken as having been closed off, is set low. This ensures to prevent malfunction that may possibly be caused when the light quantity decreases, for instance, when the shadow of the user is cast on the photodetector at a varying attitude or the photodetector becomes blurred.

Alternatively, the photodetector 25 may be located at such a position that when the user takes hold of the camera 10 with both hands, is reached by a bit little movement of the finger. This enables the user to take firm hold of the camera 10 with both hands, helpful for prevention of camera shake. The camera 10 is also friendly to tender children or those who have trouble in fine manipulation, because a little bit movement of the finger is only needed while it is held up with both hands.

(3) The body of the camera 10 is provided with a light source. This light source is located at a position that faces the photodetector 25 and at a suitable distance from it, so that a finger, a shading part or the like can be inserted in or deinserted from between the photo-detector 25 and the light source to change the intensity of light incident on the photodetector 25. As such an intensity change of light is used, it allows the shutter to be put into operation. The provision of the light source in this embodiment ensures that even in a dark place, the shutter can be put into operation.

Preferably in this embodiment, whether the power source for the light source is turned on or off is selectable by the user. For instance, in bright circumstances, ambient light is incident on the photodetector 25. For this reason, more than enough light quantity differences can be detected by the photodetector 25, even as compared with the case where it is closed off as by a finger. In other words, the shutter can be put into operation without recourse to light from the light source. With this embodiment wherein the power source for the light source may be shut off, it is thus possible to cut down the power consumption of the imaging system.

It is also preferable that visible wavelengths are chosen as the wavelength of light coming out of the light source, because the light from that light source can be so visually observable that whether light is available or shaded off can be easily checked up.

It is here noted that the light emanating from the light source may be infrared light. Especially in dark environments, even feeble light may possibly have influences on taking. In this case, if the light coming from the light source is infrared light, it will not affect taking. Even where feeble light has some trouble, the infrared light is invisible, offering no such problems.

Throughout the above embodiments (1) to (3), a photodetection mode is preferably installed. As there are changes in the intensity of light detected at the photodetector 25 in the photodetection mode, it triggers the shutter into operation. With the photodetection mode not set, however, the shutter is not triggered. As the imaging system is placed in the photodetection mode just before taking, it prevents malfunction such as a sudden shutter actuation in choosing composition. As the power source for the photodetector 25 is designed to turn on only in the photodetection mode, it is helpful for cutting down power consumptions.

In the instant example, for instance, photodiodes, phototransistors, photoconductive elements, and pyro-electric elements (especially in the case of an infrared light source) may be used as the photodetector 25. As the light source, for instance, light emitting diodes, laser diodes, and lamps may be used. Alternatively, the light from the light source may be trained on the photodetector by way of a light guide.

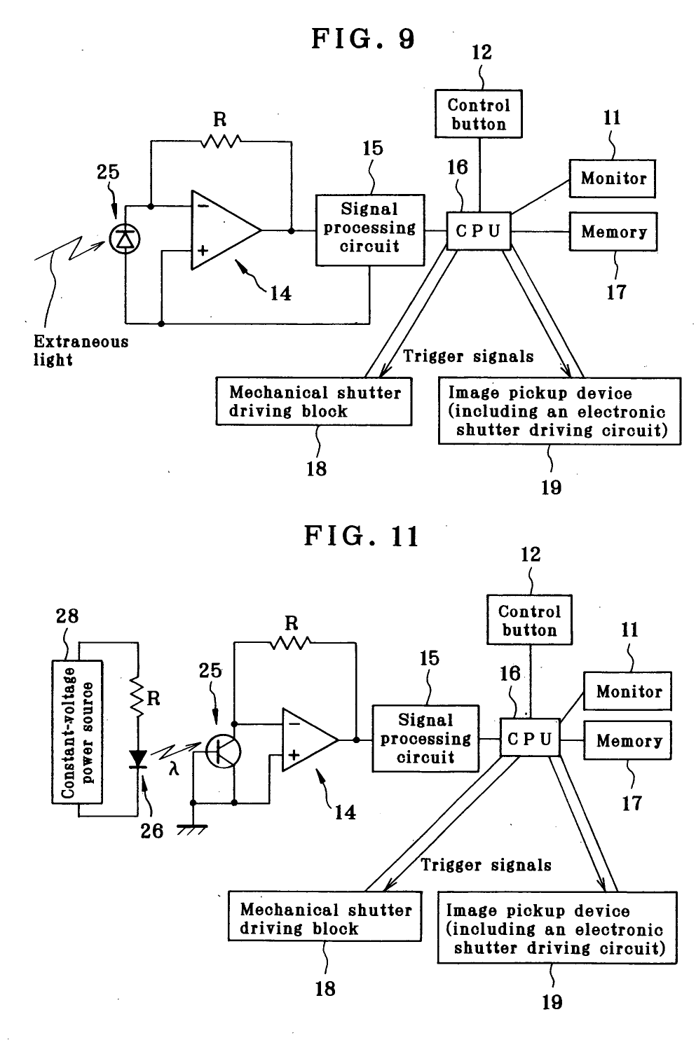

One exemplary processing of how the shutter is put into operation in Example 2 is now explained. FIG. 9 is a block diagram illustrative of signal processing in taking according to the above embodiment (2). Here, ambient light is detected by a photodiode 25. Upon incidence of the ambient light on the photodiode 25, a given photocurrent is produced from the photodiode 25 depending on the intensity of that light. This output current is amplified at an amplifier 14 comprising an operational amplifier for conversion into an electric signal that in turn enters a signal processing circuit 15, where whether or not its magnitude is greater than a threshold value is determined. If it is greater than the threshold value, the shutter is to be put into operation, and a given control signal is produced from the signal processing circuit 15 and sent to CPU 16.

At CPU 16, whether or not the photodetection mode is set by a control button 12 is determined. With the photo-detection mode set, a shutter driving trigger single is sent from CPU 16 to a mechanical shutter driving block 18 with the result that the mechanical shutter is put into operation. Since another trigger signal is also sent to an image pickup device 19, an electronic shutter on the image pickup device 19 is operated in association with operation of the mechanical shutter, and image information is stored as well. In this way, images are taken. With the photodetection mode not set, on the other hand, both the mechanical shutter and the electronic shutter are not driven. While both the mechanical shutter and the electronic shutter are used in this example, it is understood that it is possible to rely upon only one of them. With the mechanical shutter alone, the trigger signals are fed to the mechanical shutter driving block 18 and the image pickup device 19 to put the mechanical shutter into operation and store the image information. With the electronic shutter alone, on the other hand, the trigger signal is fed to the image pickup device 19 to put the electronic shutter into actuation and store the image information.

It is here noted that CPU 16 is connected with a monitor 11, a memory 17 and the image pickup device 19, so that images picked up by the operation of the shutter are stored in the memory 17, and the images picked up by the image pickup device 19 and the images stored in the memory 17 are displayed on the monitor 11 by way of a control signal from the control button 12. Although the processing unit used herein is built up of the signal processing circuit 15, it may further include CPU 16.

How to take images according to the above embodiment (3) is now explained. FIGS. 10(a) and 10(b) show one exemplary arrangement. As shown in FIG. 10, there is provided a dent 27 for receiving a finger F when the body of a camera 10 is held up with both hands. A light source is opposed to a photodetector with the dent 27 located between them. In this embodiment, a light emitting diode 26 and a photodiode 25 are used as the light source and the photodetector, respectively. As shown in FIG. 10(a), the light emitting diode 26 constantly emits light, and light from it is incident on the photodiode 25. The light emitting diode 26 used herein continuously gives out light; however, that may blink at a given time interval. In this state, the user chooses composition with the imaging system directed to the subject to be taken. Once the timing of taking an image is decided, the finger F is placed in the dent 27, as shown in FIG. 10(b), whereupon the light from the light emitting diode 26 is cut off by the finger F, resulting in a sharp drop of the quantity of light incident on the light emitting photodiode 25. As that light quantity change is detected, the shutter is put into operation so that the image can be taken.

FIG. 11 is a block diagram illustrative of signal processing in the arrangement of FIG. 10. A constant-voltage power source 28 is provided to drive a light emitting diode 26. With the photodetection mode set, power is supplied from the constant-voltage power source 28 to the light emitting diode 26, so that light is directed from the light emitting diode 26 toward a photo-transistor 25. In the photodetection mode, therefore, light is constantly entered in the phototransistor 25. As, in this state, the finger F is inserted between the light emitting diode 26 and the phototransistor 25 as shown in FIG. 10(b), the light incident on the phototransistor 25 is cut off. A change in the intensity of this light is produced from the phototransistor 25 in the form of a current change. The rest of processing is much the same as in FIG. 9.

### EXAMPLE 3

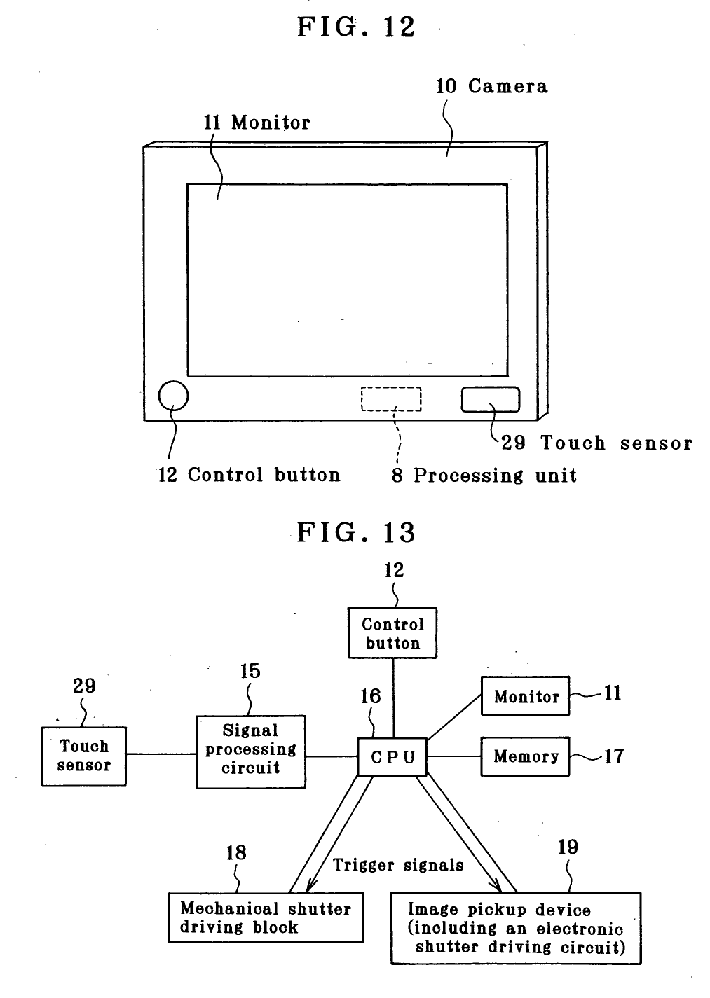

FIG. 12 is a rear view of the imaging system according to Example 3. This imaging system, too, is embodied in the form of such a card-type camera 10 as in Example 1. It is here noted that the camera 10 may be an optical system that has no scan mirror, and instead includes a mirror or reflecting prism for bending an associated optical path or, alternatively, the camera 10 may have a finder not shown.

As depicted in FIG. 12, the camera 10 comprises on its back surface a touch sensor 29, a monitor (e.g., a liquid crystal display) 11 and a control button 12, with a built-in processing unit 8. It is here noted that the image pickup optical system, control circuit, memory, etc. that must be included in the camera 10 are not shown. The control button 12 is provided to set taking conditions, etc. and perform image control (processing) in a memory. As the user operates the control button 12, for instance, it causes a cursor to move across a menu appearing on the monitor 11. Then, as menu items are chosen as an example, mode switchover or sensitivity switchover is settable or, alternatively, image lists or the desired image appears.

The imaging system of this example comprises the touch sensor 29 as a contact type detector. As a touch event is detected by the touch sensor 29 upon taking, it allows that touch event to be used as a trigger to put the shutter into operation for setting off taking. That is, the imaging system of the present example is provided with the touch sensor 29 as the input portion for putting the shutter into operation, and that touch sensor 29 plays a shutter release button.

With the imaging system of this example, the shutter can be put into operation by a little bit touch. Thus, the imaging system, albeit being of the touch type, enables the shutter to be put into operation without applying force thereto with the result that blur-free good images can be obtained. The optical system, because of being less susceptible to distortion and decentration, ensures good images. A light touch on the touch sensor 29 is only needed; this is not only helpful for prevention of camera shake, but also ensures that even with the camera 10 held up with one hand, it is less susceptible to camera shake.

No reliance on any shutter release button enables the number of control buttons to be diminished, making the monitor 11 larger.

Preferable in the imaging system of this example, too, a touch detection mode is installed. It is only in the touch detection mode that a shutter actuation trigger signal is generated; it is possible to prevent an inadvertent touch on the touch sensor 29, which may otherwise cause actuation of the shutter and, hence, the camera at a wrong place.

The timing of setting off taking may be determined by how many times the touch sensor 29 is touched. In the simplest case, taking starts instantaneously with one touch on the touch sensor 29. In a bit more complicated case, however, a few touches are needed to set off taking. For instance, the first touch places the camera in the touch detection mode, and the second touch puts it in the taking enabling mode. In other words, taking cannot be set off without two touches on the touch sensor 29. This will prevent any inadvertent touch of the finger on the touch sensor 29, which may otherwise cause actuation of the shutter at a wrong place.

The touch sensor 29 may have other roles. For instance, in a display mode in which taken images are displayed or a taking condition setting mode other than the taking enabling mode (toucht detection mode), the touch sensor 29 may be used as the control button 12. Alternatively, the touch sensor 20 may have various control functions depending on how many times the touch sensor 29 is continuously touched, and for each touch pattern, and so the touch sensor 29 can gain various controls. As a result, the number of other control buttons is diminished and the monitor 11 is made larger as well.

Depending on how many times the touch sensor 29 is touched, one mode may be switched over to another; the cursor may be moved across the monitor 11; and so on.

One exemplary processing of how the shutter is put into operation in Example 3 is now explained. FIG. 13 is a block diagram illustrative of signal processing using the touch sensor 29. A touch signal detected at the touch sensor 29 enters a signal processing circuit 15. Upon entrance of the touch signal, a given control signal is produced from the signal processing circuit 15 to put the shutter into operation. This control signal is in turn sent to CPU 16.

At CPU 16, whether or not the touch detection mode is to be set is determined by a control button 12 or the number of touch events. If the touch detection mode is set, a shutter-driving trigger signal is sent from CPU 16 to a mechanical shutter driving block 18 with the result that the mechanical shutter is operated. Since another trigger signal is also sent to an image pickup device 19, an electronic shutter on the image pickup device 19 is operated in association with the operation of the mechanical shutter, and image information is stored as well. In this way, images are taken. With the touch detection mode not set, on the other hand, both the mechanical shutter and the electronic shutter are not driven. While both the mechanical shutter and the electronic shutter are used in this example, it is understood that it is possible to rely upon only one of them. With the mechanical shutter alone, the trigger signals are fed to the mechanical shutter driving block 18 and the image pickup device 19 to put the mechanical shutter into operation and store the image information. With the electronic shutter alone, on the other hand, the trigger signal is fed to the image pickup device 19 to put the electronic shutter into operation and store the image information.

It is here noted that CPU 16 is connected with a monitor 11, a memory 17 and the image pickup device 19, so that images picked up by the operation of the shutter are stored in the memory 17, and the images picked up by the image pickup device 19 and the images stored in the memory 17 are displayed on the monitor 11 by way of a control signal from the control button 12. Although the processing unit used herein is built up of the signal processing circuit 15, it may further include CPU 16.

Exemplary controls using the touch sensor 29 are now explained.

When the camera 10 is in modes except for the touch detection mode, one touch places it in the touch detection mode, and one more touch puts the shutter into operation, setting off taking.

When the camera 10 is in the touch detection mode, one after another touch releases it from the touch detection mode, causing it to go back to the previous mode.

When the camera 10 is in the touch detection mode, one after another touch places it in a flash setting mode for choosing how to emit light. For each touch, there is a switchover such as auto→prevention of red eye→forced light emission→inhibition of light emission. One after another touch releases the camera 10 from the flash setting mode.

When the camera 10 is in the display mode, one touch causes images to appear successively on the monitor.

When the camera 10 is in the display mode, one after another touch places it in an index display mode. For each touch, one selected image turns to another. One after another touch brings the index display to an end.

While several exemplary controls using the touch sensor 29 have been mentioned, it is understood that many other controls are possible.

### EXAMPLE 4

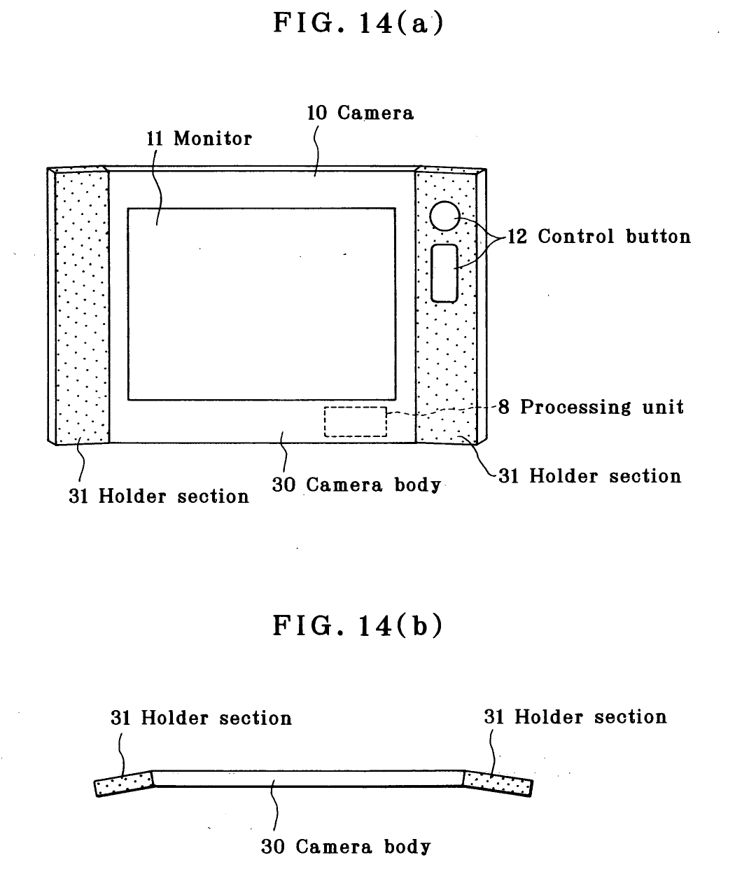

FIG. 14 is a rear view of the imaging system of Example 4. This imaging system, too, is embodied in the form of such a card-type camera 10 as in Example 1. It is here noted that the camera 10 may be an optical system that has no scan mirror, and instead includes a mirror or reflecting prism for bending an associated optical path or, alternatively, the camera 10 may have a finder not shown.

As depicted in FIG. 14, the camera 10 comprises on its back surface a monitor (e.g., a liquid crystal display) 11 and a control button 12, with a built-in processing unit 8. It is here noted that the image pickup optical system, control circuit, memory, etc. that must be included in the camera 10 are not shown. The control button 12 is provided to set taking conditions, etc. and perform image control (processing) in a memory. As the user operates the control button 12, for instance, it causes a cursor to move across a menu appearing on the monitor 11. Then, as menu items are chosen as an example, mode selection or sensitivity selection is settable or, alternatively, image lists or the desired image appears.

The camera 10 of this example includes holder sections 31 on both sides of its body 30. As depicted in FIG. 14(b), each holder section 31 can be slightly bent down at a boundary between it and the camera body 30. Correspondingly, the camera 10 of Example 4 is provided with bending detection means for detecting that the holder sections 31 are bent down with the camera 10 held up with both hands. In the camera 10 of this example, therefore, such bending is used as a trigger to put the shutter into operation, setting off taking. Thus, the imaging system of this example comprises the bending detection means as the input portion for putting the shutter into operation, and the bending detection means plays a shutter release button.

With the camera 10 of Example 4, the shutter can thus be put into operation without applying force to the camera body 30. For this reason, the optical system is not susceptible to distortion and decentration during taking, so that good images can be obtained.

The camera 10 is also less susceptible to shake, because it can be operated with held up with both hands. Further, the camera 10 is friendly to those who have trouble in fine manipulation, because it can be operated without finger movement as held up with both hands.

In the arrangement shown in FIG. 14, the holder sections 31 are bendable at the boundaries between them and the camera body 30. It is understood, however, that each holder section 31 may be designed to be bent by deflection in itself.

In this example, the shutter is put into operation upon bending, as described above. Conversely, the shutter may be put into operation when each holder section is bent down and then restored back to the original state.

In the arrangement shown in FIG. 14(b), both the right and left holder sections 31 are designed to be bent down. However, only one of the holder sections 31 may be designed to be bent down. In this case, a part or the whole of the optical system is located on the side of another holder section 31 that is kept from bending. This ensures effective prevention of decentration of the optical system due to distortion.

Preferably in Example 4, too, a bending detection mode is installed. That is, the camera is designed such that a shutter actuation trigger signal is generated only in the bending detection mode. Thus, if the camera is placed in the bending detection mode just before taking, it is then possible to prevent malfunction such as an abrupt shutter actuation at the time of choosing composition or the like. If power is supplied to the bending detection means only in the bending detection mode, then power consumptions can be saved.

Various controls may be gained while the camera 10 is held up with both hands, and the camera 10 is friendly to those who have trouble in fine manipulation with fingers. For instance, mode selection, movement of a cursor across the monitor 11 and so on may be carried out.

The bending detection means may have many other roles. For instance, in a display or setting mode except for the taking enabling (bending detection) mode, the bending detection means may be used as the control button 12. The bending detection means may also take a different role for each of a succession of bending events. With the sole use of the bending detection means, it is thus possible to carry out various controls, for instance, mode selection, and movement of the cursor across the monitor 11. Consequently, the number of other control buttons can be diminished, and the monitor 11 can be made larger, correspondingly. Various controls may be gained as the camera 10 is held up with both hands. Thus, the imaging system of this example is friendly to those who have trouble in fine manipulation with fingers.

(1) Pressure Sensor

A pressure sensor is located at the boundary between the camera body 30 and the holder section 31 or within the holder section 31. As the boundary between the holder section 31 and the camera body 30 is bent down or the holder section 31 is distorted by itself, there is a change in the pressure on the pressure sensor. When this pressure is greater than a certain threshold value, the shutter is triggered into operation.

(2) Light Source and Photodetector

A light source is located at the camera body 30 and a photodetector is located at the holder section 31, or both are located in the holder section 31. The light source is then opposed to the photodetector. In this state, as light from the light source is incident on the photodetector, a given signal is sent out of the photo-detector. Here, as the boundary between the holder section and the camera body or the holder section is bent down, there is a change in the positions of the light source and the photodetector, whereupon the light emanating from the light source does not enter the photo-detector or the proportion of the incident light on the photodetector decreases. Here, as the photodetector detects that the intensity of light (a given signal) is lower than the threshold value, the shutter is put into operation.

When the shutter is to be put into operation upon restoration from the bent state, the shutter is operated at the time that the output (light intensity) from the photodetector is once lower than the threshold value and then greater than that. Alternatively, the light source and the photodetector are located such that they are in opposition to each other in the bent state. When the output from the photodetector is once greater than the threshold value and then lower than that, the shutter is operated.

The bending detection means in this example are now explained.

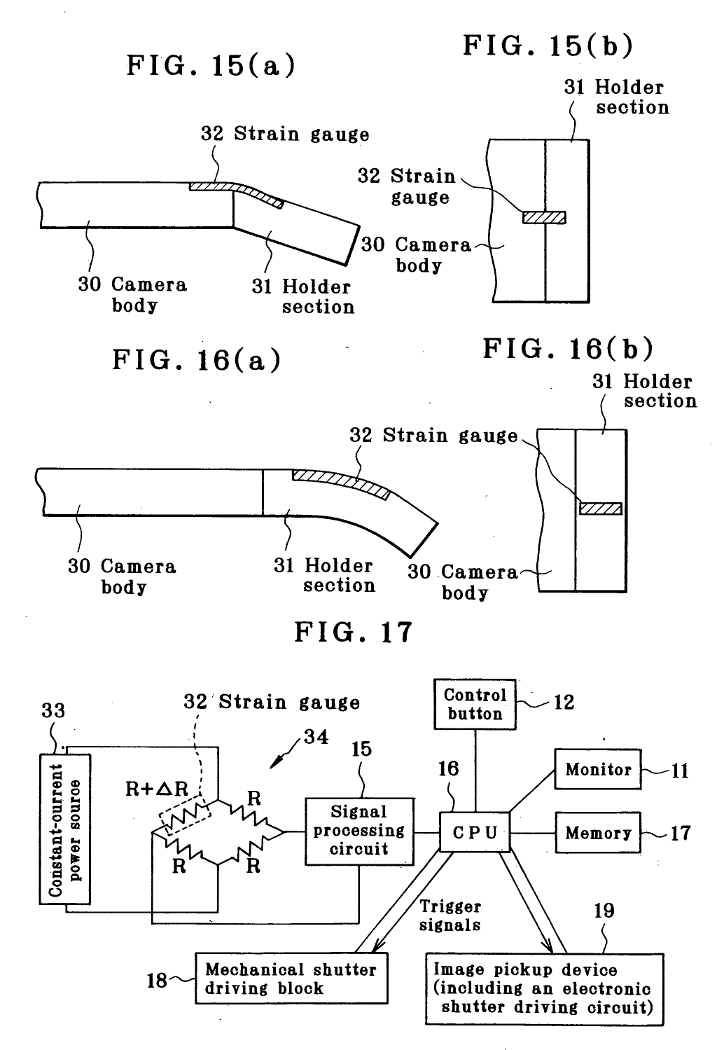

FIGS. 15 to 20 show specific examples wherein a pressure sensor is used as the bending detection means. FIGS. 15 to 17 show examples wherein a strain gauge is used as the pressure sensor. More specifically, FIGS. 15(a) and 15(b) are a partially horizontal section view and a partial front view, respectively, of a camera wherein a strain gauge 32 is applied over inside portions of a camera body 30 and a holder section 31 at their boundary, and FIGS. 16(a) and 16(b) are a partially horizontal section view and a partial front view, respectively, of a strain gauge 32 applied over an inside portion of a holder section 31. In the arrangement of FIG. 15, as the boundary portion between the holder section 31 and the camera body 30 is bent down, it is detected in the form of a resistance value change. In the arrangement of FIG. 16, as the holder section 31 is deflected by itself, it is detected by the strain gauge 31 in the form of a resistance value change.

One exemplary processing of how the shutter is put into operation in this example is now explained. FIG. 17 is a block diagram of signal processing using a strain gauge 32. The strain gauge 32 is connected as one resistance in a bridge circuit 32 connected to a constant-current power source 33. As the resistance of the strain gauge 32 changes in response to a bending of the boundary portion between the holder section 31 and the camera body 30 or a deflection of the holder section 31 per se, a signal (voltage) corresponding to that bending or deflection appears on the detection end of the bridge circuit 34. That signal enters a signal processing circuit 15 where whether or not the magnitude of the signal is greater than a given threshold value is determined. Here if it is greater than the threshold value, the shutter is to be put into operation, and a given control signal is produced from the signal processing circuit 15. This control signal is sent to CPU 16.

At CPU 16, whether or not the bending detection mode is set by a control button 12 is determined. With the bending detection mode set, a shutter-driving trigger signal is sent from CPU 16 to a mechanical shutter driving block 18 with the result that the mechanical shutter is operated. Since another trigger signal is also sent to an image pickup device 19, an electronic shutter on the image pickup device 19 is operated in association with the operation of the mechanical shutter, and image information is stored as well. In this way, images are taken. With the bending detection mode not set, on the other hand, both the mechanical shutter and the electronic shutter are not driven. While both the mechanical shutter and the electronic shutter are used in this example, it is understood that it is possible to rely upon only one of them. With the mechanical shutter alone, the trigger signals are fed to the mechanical shutter driving block 18 and the image pickup device 19 to put the mechanical shutter into operation and store the image information. With the electronic shutter alone, on the other hand, the trigger signal is fed to the image pickup device 19 to put the electronic shutter into operation and store the image information.

It is here noted that CPU 16 is connected with a monitor 11, a memory 17 and the image pickup device 19, so that images picked up by the operation of the shutter are stored in the memory 17, and the images picked up by the image pickup device 19 and the images stored in the memory 17 are displayed on the monitor 11 by way of a control signal from the control button 12. Although the processing unit used herein is built up of the signal processing circuit 15, it may further include CPU 16.

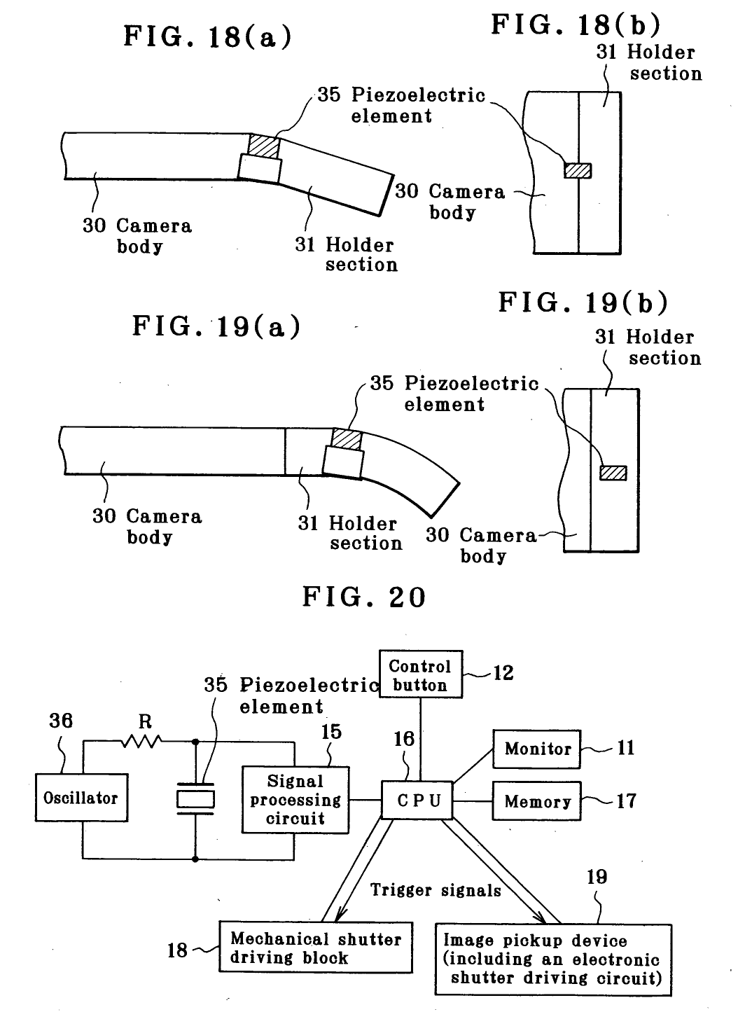

FIGS. 18 to 20 show examples wherein a piezoelectric element is used as the pressure sensor. More specifically, FIGS. 18(a) and 18(b) are a partially horizontal section view and a partial front view, respectively, of a camera wherein a piezoelectric element 35 is located in a boundary portion of a camera body 30 and a holder section 31. In the arrangement of FIG. 18, the piezoelectric element 35 is astride the camera body 30 and the holder section 31. Therefore, as the boundary portion between the holder section 31 and the camera body 30 is bent down, it is detected by the piezoelectric element 35 in the form of an impedance change or a resonance frequency (phase) change. As shown, the piezoelectric element 35 is sandwiched between the front and the rear members of the camera body 30 and the holder section 31.

FIGS. 19(a) and 19(b) are a partially horizontal section view and a partial front view, respectively, of a camera wherein a piezoelectric element 35 is embedded within (the interior of) a holder section 31. In the arrangement of FIG. 19, the piezoelectric element 35 is sandwiched between the front member and the rear member of the holder section 31. Therefore, as the holder section 31 per se is deflected, it is detected by the piezoelectric element 35 in the form of an impedance change or a resonance frequency (phase) change.

One exemplary processing of how the shutter is put into operation in this example is now explained. FIG. 20 is a block diagram of signal processing using a piezoelectric element 35. The piezoelectric element 35 is connected parallel with an oscillator 36. As pressure is applied on the piezoelectric element 35 by a bending of the boundary portion between the holder section 31 and the camera body or a deflection of the holder section 31 per se, an impedance change or a resonance frequency (phase) change corresponding to that bending or deflection appears as a signal across the piezoelectric element 35. That signal enters a signal processing circuit 15, where whether or not the magnitude of the signal is greater than a given threshold value is determined. Here if it is greater than the threshold value, the shutter is to be put into operation, and a given control signal is sent out from the signal processing circuit 15. This control signal is sent to CPU 16.

At CPU 16, whether or not the bending detection mode is set by a control button 12 is determined. With the bending detection mode set, a shutter-driving trigger signal is sent from CPU 16 to a mechanical shutter driving block 18 with the result that the mechanical shutter is operated. Since another trigger signal is also sent to an image pickup device 19, an electronic shutter on the image pickup device 19 is operated in association with the operation of the mechanical shutter, and image information is stored as well. In this way, images are taken. With the bending detection mode not set, on the other hand, both the mechanical shutter and the electronic shutter are not driven. While both the mechanical shutter and the electronic shutter are used in this example, it is understood that it is possible to rely upon only one of them. With the mechanical shutter alone, the trigger signals are fed to the mechanical shutter driving block 18 and the image pickup device 19 to put the mechanical shutter into operation and store the image information. With the electronic shutter alone, on the other hand, the trigger signal is fed to the image pickup device 19 to put the electronic shutter into operation and store the image information.

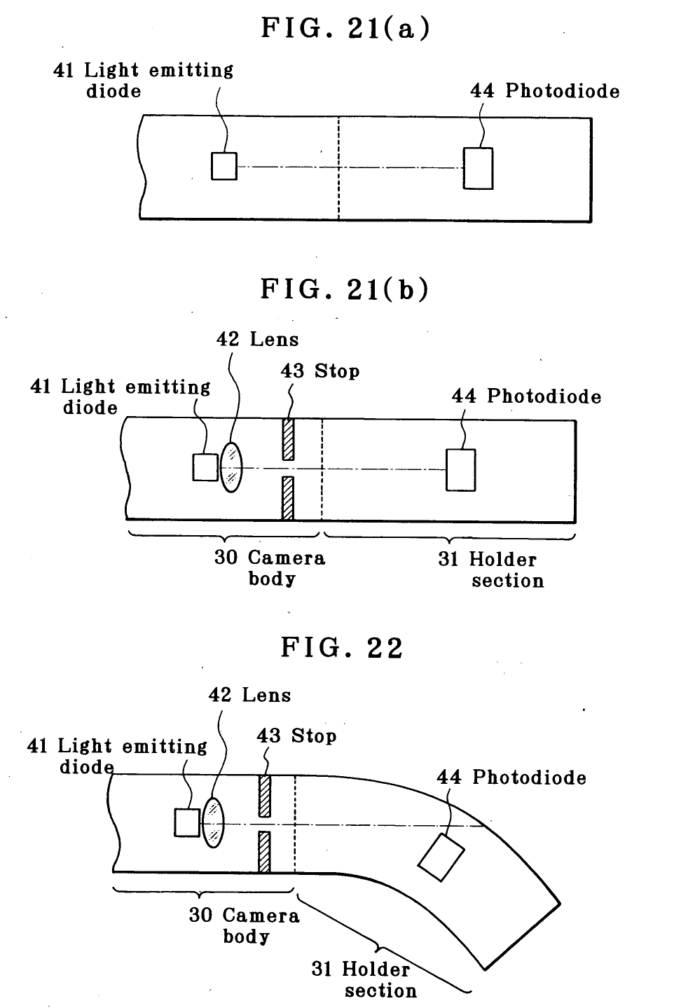

FIGS. 21 to 24 show specific examples wherein the light source and the photodetector are used as the bending detection means. FIG. 21 is illustrative of the construction of one example. More specifically, FIG. 21(a) shows one basic construction. As shown, a light source and a photodetector are located at boundary portions between a camera body 30 and a holder section 31. The light source comprising a light emitting diode 41 is located on the side of the camera body 30. On the other hand, the photodetector comprising a photodiode 44 is located on the side of the holder section 31. The light emitting diode 41 and the photodiode 44 are located within the camera body 30 and the holder section 31 in such a way that they are in opposition to each other.

FIG. 21(b) is illustrative of a more preferred arrangement of the bending detection means. In this arrangement, a lens 42 and a stop 43 are located between the light emitting diode 41 and the photodiode 44. Therefore, light emanating from the light emitting diode 41 is converted through the lens 42 into a parallel light beam, which is in turn converted into a slender light beam upon passing through the stop 43. The diameter of the light beam relative to the reception area of the photo-diode 44 becomes smaller as compared with the arrangement of FIG. 21(a). Accordingly, the sensitivity of the photo-diode 44 to a displacement, i.e., the degree of bending of the boundary portion becomes high.

FIG. 21 is illustrative of the holder section 31 that is not deflected or the boundary between the holder section 31 and the camera body 30, which is not bent down. In this state, the light emanating from the light emitting diode 41 propagates along the interior of the camera body 30 and holder section 31, and then enters the photodiode 44. Therefore, a signal (current) of given magnitude is produced out of the photodiode 44.

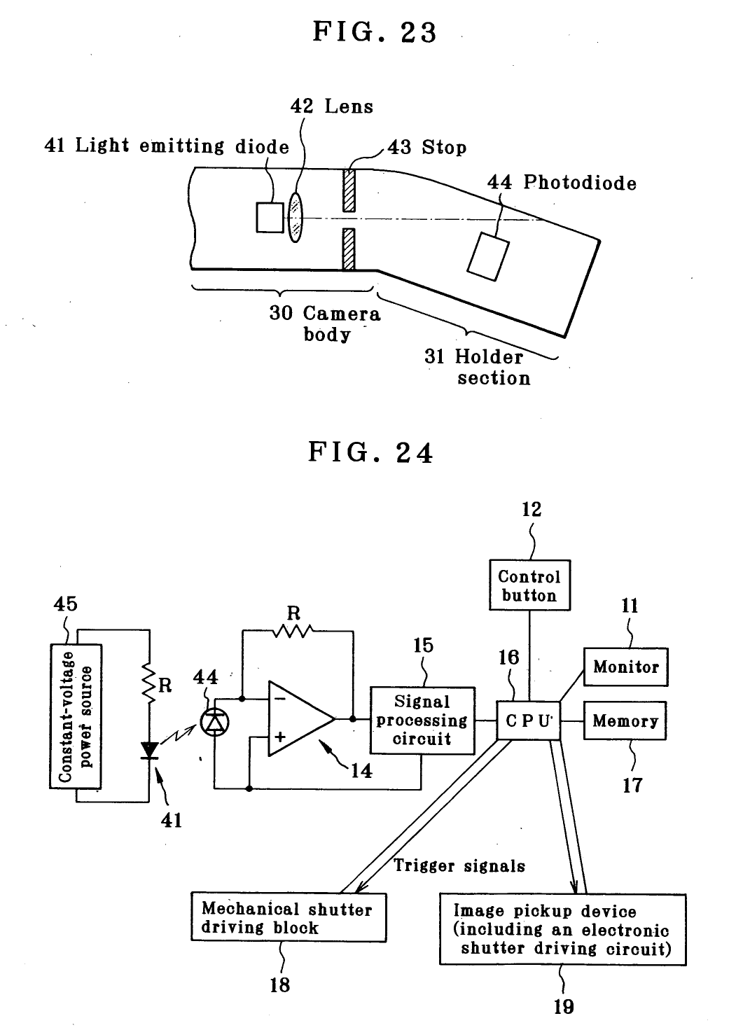

FIG. 22 is illustrative of what state the holder section 31 is deflected in. In this state, too, the light emanating from the light emitting diode 41 propagates along the interior of the camera body 30 and holder section 31. However, there is no photodiode 44 in the direction of propagation of that light. Accordingly, no signal (current) is produced out of the photodiode 44. It is thus possible to detect that the holder section 31 is being deflected. That the boundary portion between the holder section 31 and the camera body 30 is being bent down is similarly detected, as shown in FIG. 23.

Thus, as the quantity of light detected at the photodiode 44 changes beyond the threshold value, it puts the shutter into operation. In this way, images are taken. Alternatively, the shutter may be put into operation upon restoration from the bent state. In this case, when the quantity of light detected at the photodiode 44 is greater than the threshold value, the shutter is triggered into operation.

One exemplary processing of how the shutter is put into operation in this example is now explained. FIG. 24 is a block diagram of signal processing using a light source and a photodetector. A constant-voltage power source 45 is provided to drive the light emitting diode 41. Power is supplied form the constant-voltage power source 45 to the light emitting diode 41. Therefore, light is directed from the light emitting diode 41 toward the photodiode 44, and with the photodetection mode set, light is constantly incident on the photodiode 44. In this state, as the photodiode 44 is displaced from the direction of propagation of light as shown in FIG. 22 or FIG. 23, there is no light incident on the photodiode 44. A change in the intensity of this light is produced out of the photodiode 44 in the form of a current change. The rest of processing is much the same as in FIG. 9. For the photodetector used to detect light to put the shutter into operation as shown in FIG. 21 to 24, for instance, photodiodes, phototransistors, photoconductive elements, and pyroelectric elements (especially in the case of an infrared light source) may be used, and for the light source, for instance, photodiodes, laser diodes, and lamps may be used.

### EXAMPLE 5

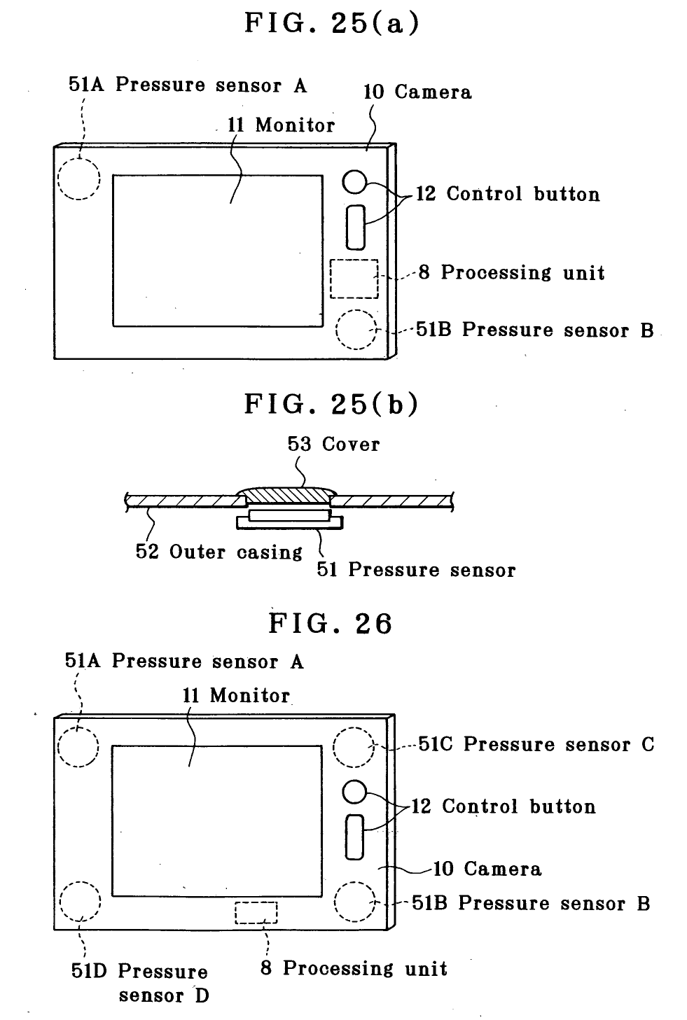

FIG. 25 is a rear view of the imaging system of Example 5. This imaging system, too, is embodied in the form of such a card-type camera 10 as in Example 1. It is here noted that the camera 10 may be an optical system that has no scan mirror, and instead includes a mirror or reflecting prism for bending an associated optical path or, alternatively, the camera 10 may have a finder not shown.

As depicted in FIG. 25, the camera 10 comprises on its back surface a monitor (e.g., a liquid crystal display) 11 and a control button 12, with a built-in processing unit 8. It is here noted that the image pickup optical system, control circuit, memory, etc. that must be included in the camera 10 are not shown. The control button 12 is provided to set taking conditions, etc. and perform image control (processing) in a memory. As the user operates the control button 12, for instance, it causes a cursor to move across a menu appearing on the monitor 11. Then, as menu items are chosen as an example, mode selection or sensitivity selection is settable or, alternatively, image lists or the desired image appears.

The camera 10 of this example comprises such pressure sensors 51A and 51B as shown, the monitor 11 and the control button 12. In the instant example, two such pressure sensors 51A and 51B are positioned at both ends of one diagonal direction as shown in FIG. 25(a). As the user grips both the diagonal two pressure sensors 51A and 51B at the same time to apply pressure thereto, it triggers the shutter into operation to start taking. In other words, the pressure sensors 51A and 51B play a shutter release button role.

Thus, the imaging system of this example is less susceptible to shake, because the shutter can be put into operation with the camera held up with both hands. An imaging system having only one pressure sensor tends to become instable upon applying force thereto, because grip pressure is applied to only one site. With this example, however, symmetric force can be applied to the camera 10 because two diagonal sites are gripped during taking. Therefore, the camera 10 is held up in a stable manner, and is less susceptible to shake. Further, the camera 10 is friendly to those who have trouble in fine handling, because of no need of fine manipulation by fingers.

For the site to receive pressure, it is only needed to make the exposed surface of the pressure sensor 51 (51A, 51B) easily deformable. For instance, a camera casing 52 is holed, as shown in FIG. 25(b), in a position corresponding to the pressure sensor 51 to be mounted, and a cover 53 is then placed over the hole. For the cover 53, for instance, easily deformable materials such as rubbers or flexible plastics may be used. The pressure sensor 51, because the cover 53 of easily deformable material is placed over it, is easy to handle even with weak pressure. Even when pressure is given to the cover 53, any force is not applied to other portions of the camera casing 52, because only the cover 53 over the pressure sensor 51 is deformed. For this reason, it is possible to provide effective prevention of decentration of the optical system by distortion of the camera itself.

Preferably in this example, too, a pressure detection mode is installed. That is, the camera is designed such that a shutter actuation trigger signal is generated only in the bending detection mode. This ensures to prevent actuation of the shutter by malfunction such as an inadvertent gripping of the pressure sensors at the standby stage for taking. It is noted that since the card-type camera is thin, the pressure sensor is pressed down as if the card were pinched.

The pressure sensors 51A and 51B may have functions other than the shutter release button function. This is helpful for diminishing the number of other operation buttons with the result that the monitor 11 can be made larger.

For instance, as the pressure sensor 15A is pressed down, an autofocus function works, and while it stays pressed down, there is a fixed focus. As, in this state, the pressure sensor 51B is further pressed down, the shutter is placed into operation. This ensures that while the camera is held up with both hands in the moment of taking, it can be precisely focused on a subject.

Besides, the pressure sensors may have various functions such as taking mode selection and cursor movement across the monitor 11. At this time, the functions of the pressure sensors 51A and 51B may be varied depending on various modes inclusive of taking, display and setting modes. Thus, the camera can have many more functions that can be implemented without moving fingers while gripped.

In this example, two pressure sensors are located as shown in FIG. 25(a); however, three or more pressure sensors may be located. For instance, if four pressure sensors are located at four corners of the rear side of the camera 10 as shown in FIG. 26, selection can then be made from pairs of diagonal pressure sensors 51A, 51B and 51C, 51D with grip capability in mind. In this case, too, the user can take firm hold of the camera 10 with both hands from the right-and-left direction. Alternatively, selection may be made from pairs of pressure sensors at horizontally symmetric positions, for instance, a pair of pressure sensors 51A, 51C. At this time, such pairs may be set in such a way that the desired pair is selectable. This ensures that different functions can be allocated to the pair that is not selected, so that more functions can be implemented by gripping alone.

The functions of each pressure sensor 51A, 51B, 51C, 51D may be varied depending on specific modes such as taking, display and setting modes. Except for the moment the shutter is put into operation, there is no influence of camera shake on the camera, and it is not always necessary to apply gripping pressure over two pressure sensors at diagonal positions or horizontally symmetric positions. For instance, a pair of pressure sensors 51A and 51D not located at diagonal positions or horizontally symmetric positions may be used. Alternatively, pressure may be applied over only one pressure sensor to implement the desired function.

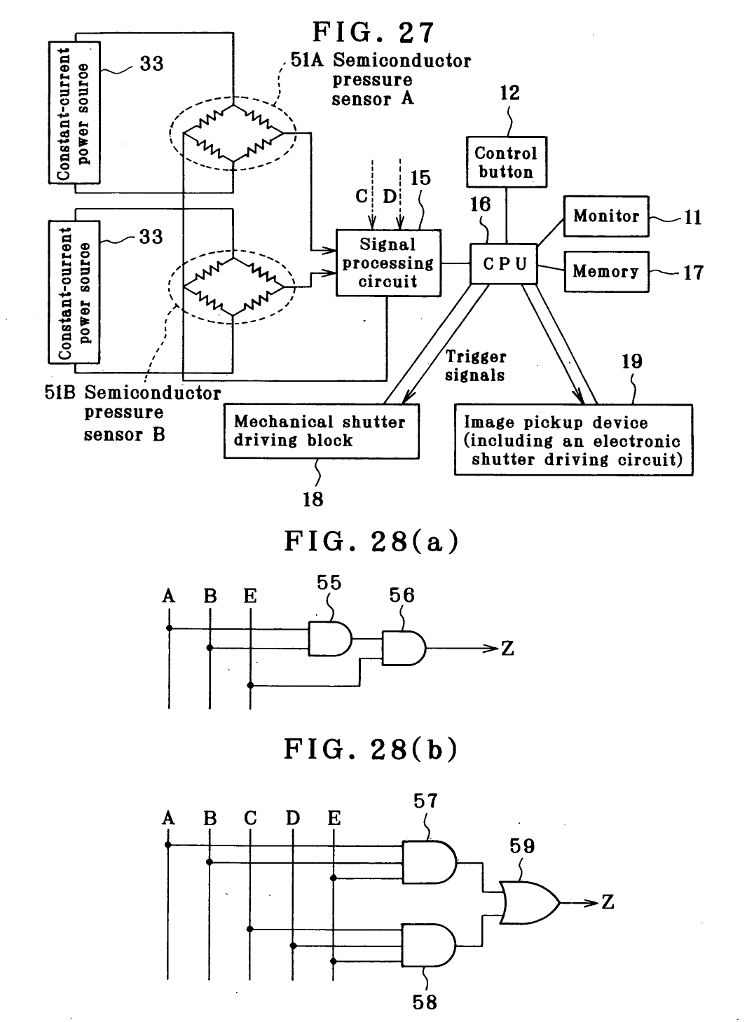

One exemplary processing of how the shutter is put into operation in this example is now explained. FIG. 27 is a block diagram of signal processing using a plurality of pressure sensors. In FIG. 27, semiconductor pressure sensors are used as the pressure sensors 51A, 51B, 51C and 51D. Each pressure sensor 51A, 51B, 51C, and 51D is connected to its associated constant-current power source 33. As gripping pressure is applied over each pressure sensor 51A, 51B, 51C, and 51D, a signal (voltage) is generated. The signal from each pressure sensor 51A, 51B, 51C, and 51D enters a signal processing circuit 15, where whether or not its magnitude is greater than a given threshold value is determined. If the magnitude is greater than the given threshold value, the shutter is to be put into operation, and a given control signal is produced out of the signal processing circuit 15. This control signal is then sent CPU 16.

At CPU 16, whether or not the pressure detection mode is set by the control button 12 is determined. With the pressure detection mode set, a shutter driving trigger signal is sent from CPU 16 to a mechanical shutter driving block 18 with the result that the mechanical shutter is operated. Since another trigger signal is also sent to an image pickup device 19, an electronic shutter on the image pickup device 19 is operated in association with the operation of the mechanical shutter, and image information is stored as well. In this way, images are taken. With the pressure detection mode not set, on the other hand, both the mechanical shutter and the electronic shutter are not driven. While both the mechanical shutter and the electronic shutter are used in this example, it is understood that it is possible to rely upon only one of them. With the mechanical shutter alone, the trigger signals are fed to the mechanical shutter driving block 18 and the image pickup device 19 to put the mechanical shutter into operation and store the image information. With the electronic shutter alone, on the other hand, the trigger signal is fed to the image pickup device 19 to put the electronic shutter into operation and store the image information.

In the foregoing explanation, the pressure detection mode is recognized at the CPU. However, this may be modified as follows. As in a logic circuit of FIG. 28(a), the outputs of pressure sensors 51A and 51B are connected to the input of an AND circuit 55, and the output of the AND circuit 55 and a signal E indicative of whether or not the pressure detection mode is set are connected to the input of an AND circuit 56. As pressures are first applied over the pressure sensors 51A and 51B in this state, it causes a pressure signal A from the pressure sensor 51A and a pressure signal B from the pressure sensor 51B to enter the AND circuit 55. When there are both signals, a signal is sent out of the AND circuit 55. This output signal becomes an input signal for one terminal of another AND circuit 56. Another input terminal of another AND circuit 56 receives the signal E indicative of whether or not the pressure detection mode is set. Therefore, only when gripping pressures are applied simultaneously over the pressure sensors 51A and 51B and the pressure detection mode is set, a shutter actuation trigger signal Z is generated.

When four pressure sensors 51A, 51B, 51C and 51D are located at four corners of the rear side of a camera 10 as in FIG. 26, reliance may be on such a circuit arrangement as shown in FIG. 28(b). In FIG. 28(b), an AND circuit 57 receives a pressure signal A from the pressure sensor 51A, a pressure signal B from the pressure sensor 51B and a trigger standby mode signal E. When three such signals are on, they enter one input terminal of an OR circuit 59. On the other hand, another AND circuit 58 receives a pressure signal C from the pressure sensor 51C, a pressure signal D from the pressure sensor 51D and a pressure detection mode signal E. When three such signals are on, they enter another input terminal of the OR circuit 59. Accordingly, even when gripping pressures are applied simultaneously over the pressure sensors 51A and 51B or the pressure sensors 51C and 51D and the pressure detection mode is set, a shutter actuation trigger signal Z is generated.

It is noted that the CPU 16 is connected with the control button 12 for setting various modes, monitor 11, memory 17 and image pickup device 19, so that images picked up by the image pickup device 19 and images stored in the memory 17 are displayed on the monitor 11 by way of signals, and images picked up by releasing the shutter are stored in the memory 17.

By the way, the shutter actuation mechanisms of Examples 1-5 are particularly suitable for use with the card-type imaging systems as exemplified in FIGS. 1, 2 and 3. As can be seen from FIGS. 1, 2 and 3, each imaging system generally comprises (1) a one-dimensional scan mirror 2 that forms a part of the bending optical system, (2) a two-dimensional image pickup device 4 having a flat image pickup plane or a one-dimensional line sensor, and (3) a one-dimensional scan mirror 2 for mirror scanning, wherein (4) at least one optical element 3 is an optical element of irregular (that is not of circular shape in section taken on a plane vertical to its optical axis), (5) lenses on the image side with respect to an optical path bending position are all of irregular shape, (6) distortion is electrically corrected, and (7) the aperture shape 6 has a fixed aperture. Such card-type imaging systems as shown in FIGS. 1, 2 and 3 have the features (1) to (7) as mentioned above. In what follows, the merits of each feature in each card-type thin imaging system are briefly explained.

(1) Bending Optical System

As the optical path is bent, it enables the thickness of the imaging system in the taking direction to be almost equal to a distance from the optical element nearest to its object side to a bending position, so that the imaging system can be thinned. The bending position should preferably be located nearer to the object side.

(2) Flat Two-Dimensional Imaging Pickup Device or One-Dimensional Line Sensor

By use of a flat two-dimensional image pickup device or one-dimensional line sensor where pixels are arranged in a direction vertical to the taking direction, the thickness of the imaging system in the taking direction can be diminished.

(3) One-Dimensional Scan Mirror

A mirror is used as an optical-path bending element, and as scanning is carried while the mirror is tilted with an axis given by a direction vertical to the taking direction, it enables the thickness of the imaging system to be diminished in the taking direction.

(4) At least one optical element is an optical element of irregular shape. The imaging system, because of being thin in the taking direction, does not require any lens of circular shape. In other words, portions of the optical element on which a light beam is not incident are removed so that the thickness of the imaging system can be diminished in the taking direction.

(5) The lenses on the image side with respect to the optical-path bending position are all of irregular shape. Removal by cutting of portions of all lenses located on the image side with respect to the optical-path bending position, on which a light beam is not incident, enables the imaging system to be thinner in the taking direction.

(6) Electrical Correction of Distortion

As barrel distortion previously produced in the optical system is electrically corrected, it enables the angle of view to be made substantially large.

(7) The aperture shape has a fixed aperture. A stop having a variable inside diameter requires some mechanical mechanism. However, a stop having a fixed inside diameter does not require any mechanical mechanism, and makes the imaging system thinner in the taking direction. It is also possible to prevent image quality from becoming worse due to diffraction by stop-down.

While the imaging system of the invention has been explained with reference to specific examples, it is understood that the invention is in no sense limited thereto, and various modifications may be possible.

According to the invention detailed above, there can be provided an imaging system wherein a shutter actuation button can be located at any desired position. There can also be provided an imaging system that, albeit being very thin in the taking direction and far more reduced than usual in terms of size and weight, is less susceptible to movement and body distortion upon taking, which ensures that the optical system is less susceptible to decentration.

1. An imaging system comprising an image pickup optical system, an image pickup device and a shutter, characterized by further comprising an input portion for putting said shutter into operation, wherein said input portion comprises a non-contact type detector.

2. The imaging system according to claim 1, characterized in that said shutter is put into operation by detection of a specific sound wave.

3. The imaging system according to claim 2, characterized by comprising a microphone as said non-contact type detector, wherein said sound wave is detected by said microphone.

4. The imaging system according to claim 3, characterized in that when said microphone detects a sound having a magnitude or frequency greater than a threshold value, said shutter is put into operation to pick up an image.

5. The imaging system according to claim 3, characterized in that when said microphone detects a preset specific voice, said shutter is put into operation to pick up an image.

6. The imaging system according to claim 3, characterized by further comprising a sound detection mode, wherein said shutter is put into operation only in said sound detection mode.

7. The imaging system according to claim 1, characterized in that said shutter is put into operation by detection of specific light.

8. The imaging system according to claim 7, characterized by using a photodetector as said non-contact type detector thereby detecting specific light.

9. The imaging system according to claim 8, characterized in that when said photodetector detects light having a light quantity greater than a threshold value, said shutter is put into operation.

10. The imaging system according to claim 8, characterized by comprising said photodetector and a light source at a position opposite to said photodetector, wherein when said photodetector detects that light emanating from said light source is shielded or a shielded state is released, said shutter is put into operation.

11. The imaging system according to claim 7, characterized by comprising a photodetection mode, wherein said shutter is put into operation only in said photo-detection mode.

12. An imaging system comprising an image pickup optical system, an image pickup device and a shutter, characterized by further comprising an input portion for putting said shutter into operation, wherein said input portion comprises a touch sensor.

13. The imaging system according to claim 12, characterized by further comprising a detection mode, wherein said shutter is put into operation only in said detection mode.

14. An imaging system comprising an image pickup optical system, an image pickup device and a shutter, characterized by further comprising an imaging system body including therein said image pickup optical system, said image pickup device and said shutter, a holder portion adjacent to said imaging system body and an input portion for putting said shutter into operation, wherein a boundary between said holder portion and said imaging system body or said holder portion per se is bendable, with bending detection means for detecting a bending of the boundary between said holder portion and said imaging system body or said holder portion per se, wherein said input portion is said bending detection means.

15. The imaging system according to claim 14, characterized in that said bending detection means comprises a pressure sensor.

16. The imaging system according to claim 14, characterized in that said bending detection means comprises a light source and a photodetector, wherein said light source is positioned in opposition to said photo-detector.

17. An imaging system comprising an image pickup optical system, an image pickup device and a shutter, characterized by further comprising an input portion and a processing unit for putting said shutter into operation, wherein said input portion comprises a plurality of detectors, and said processing unit puts said shutter into operation in response to signals produced out of at least two detectors of said detectors.

18. The imaging system according to claim 17, characterized in that said detectors comprise pressure sensors, wherein at least two of said pressure sensors are located at diagonal positions of the imaging system body, and when signals are simultaneously produced from said two pressure sensors located at said diagonal positions, said processing unit puts said shutter into operation.
